(19) United States
(12) Patent Application Publication
(10) Pub. No.: US 2026/0353069 A1
(43) Pub. Date: Nov. 5, 2026

(54) CONSENT-BASED EXPOSURE OF UE-RELATED INFORMATION TO APPLICATION FUNCTION

(71) Applicant: Apple Inc., Cupertino, CA (US)

(72) Inventors: Sudeep Manithara Vamanan, Uttenreuth (DE); Haijing Hu, Los Gatos, CA (US); Krisztian Kiss, Rancho Santa Fe, CA (US); Mona Agnel, Guildford, Surrey (GB); Shu Guo, Beijing (CN); Vivek G. Gupta, San Jose, CA (US); Walter Featherstone, Gloucestershire (GB)

(21) Appl. No.: 19/113,209

(22) PCT Filed: Sep. 30, 2022
(86) PCT No.: PCT/CN2022/123196

§ 371 Date: Mar. 19, 2025

(51) Int. Cl. H04W 12/02; H04W 12/61

(52) U.S. Cl. CPC H04W 12/02; H04W 12/61

(57) ABSTRACT

A processor, a user equipment (UE), and a network device are provided. The processor has circuitry that executes instructions to cause a UE to perform operations including: accessing an application client (AC), wherein the AC communicates with an application function (AF) on a network entity; obtaining an AF token; updating the AF token with information about consenting exposure of UE-related information to the AF; and providing the AF token to a communication network.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation (5G) New Radio (NR). The wireless communication networks facilitate mobile broadband service using technologies such as OFDM, multiple input multiple output (MIMO), advanced channel coding, massive MIMO, beamforming, and/or other features.

A user device, such as a user equipment (UE), can perform wireless communications with a network entity for executing an application based on the UE's subscription. The software of the application executed by the UE is often referred to as application client. Correspondingly, the network entity executes software to perform tasks and provide services. The tasks and services are managed by an application function. The UE and the application function communicate in a communication network, such as a 5G core network (5GC). The communication network can have one or more entities that provide network functions such as session management function (SMF), access & mobility management function (AMF), network exposure function (NEF), policy control function (PCF), data collection coordination function (DCCF), binding support function (BSF), and unified data management (UDM).

### SUMMARY

In accordance with one aspect of the present disclosure, a processor has circuitry that executes instructions to cause a UE to perform operations. The operations include accessing an application client that communicates with an application function on a network entity. The operations include obtaining an application function token (AF token) and updating the AF token with information about consenting exposure of UE-related information to the application function. The operations include providing the AF token to a communication network.

In accordance with one aspect of the present disclosure, a UE has a processor configured to perform operations. The operations include accessing an application client that communicates with an application function on a network entity. The operations include obtaining an AF token and updating the AF token with information about consenting exposure of UE-related information to the application function. The operations include providing the AF token to a communication network.

In some implementations, obtaining the AF token includes: causing the application client to receive the AF token from the application function; and obtaining the AF token from the application client. In some implementations, obtaining the AF token further includes: obtaining an indication of consenting the exposure of the UE-related information and an indication of a token expiry time from the application client.

In some implementations, obtaining the AF token includes: obtaining a message from the application client; and generating the AF token based on the message. In some implementations, the message include an indication of the UE-related information; an authorization of exposing the UE-related information to the application function; and an indication of a validity time of the exposure.

In some implementations, providing the AF token to the communication network includes providing the AF token as part of UE subscription data via application layer signaling to a UDM entity in the communication network.

In some implementations, providing the AF token to the communication network includes providing the AF token as part of protocol configuration options (PCO) to a session management (SM) entity.

In some implementations, providing the AF token to the communication network includes providing the AF token via user plane signaling to a DCCF entity in the communication network.

In some implementations, providing the AF token to the communication network includes providing the AF token via non-access stratum (NAS) transport to a PCF entity in the communication network.

In some implementations, the application client includes an edge enabler client (EEC) and the application function includes an edge enabler server (EES).

In accordance with one aspect of the present disclosure, a network device has a UDM entity and a NEF entity. The UDM entity receives, from a UE, an AF token, the AF token including an indication of consenting exposure of UE-related information to an application function entity. The NEF receives a first request from the application function entity for retrieving a UE identifier. The NEF sends a second request to the UDM entity based on the first request. In response to the second request, the UDM entity determines the UE identifier that is unique to the UE and to the application function entity. The UDM entity provides the UE identifier to the application function. The UE identifier grants the application function entity access to the UE-related information according to the indication.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2A illustrates an example wireless system in which a UE communicates with a network entity via a communication network, according to some implementations.

FIG. 2B illustrates an example AF token, according to some implementations.

FIG. 3 illustrates a flowchart showing example operations involving a UE, an application function, and one or more network functions, according to some implementations.

FIG. 4 illustrates a flowchart showing example operations involving a UE, an application function, and one or more network functions, according to some implementations.

FIG. 5 illustrates a flowchart showing example operations involving a UE, an application function, and one or more network functions, according to some implementations.

FIG. 6 illustrates a flowchart showing example operations involving a UE, an application function, and one or more network functions, according to some implementations.

FIG. 7 illustrates a flowchart showing example operations involving a UE, an application function, and one or more network functions, according to some implementations.

FIG. 8 illustrates a flowchart showing example operations involving a UE, an edge enabler server (EES), and one or more network functions, according to some implementations.

FIG. 9 illustrates a flowchart of an example method, according to some implementations.

FIG. 10 illustrates a UE, according to some implementations.

FIG. 11 illustrates an access node, according to some implementations.

### DETAILED DESCRIPTION

When a UE and an application function communicate to execute an application over a communication network, the application function may need to invoke services managed by the NEF to obtain UE-related information. These services may request the application function to provide a UE identifier (ID) before granting exposure of the UE-related information to the application function. However, the UE, for various reasons relating to security or privacy, may choose not to share certain IDs, such as mobile station integrated services digital network (MSISDN) or subscription permanent identifier (SUPI), to the application function. One possible approach to allow the application function to access the UE-related information is to translate the internet protocol (IP) address or the Media Access Control (MAC) address of the UE to a temporary UE ID. The translation can be done by, e.g., calling a 5GC service Nnef_UEId. In particular, the Nnef_UEId service receives an IP address or a MAC address of the UE, interacts with BSF to retrieve session binding information, and outputs a temporary UE ID, such as SUPI, that is specific to the application function that requests access to the UE-related information. However, the temporary UE ID is generated by the 5GC without considering the UE's needs, and the UE may not be able to control what information is accessible by the application function.

This disclosure is made in light of the need for protecting certain UE-related information when an application function requests access. As described in detail below, implementations of this disclosure support exposure of UE-related information based on the UE's express consent. In particular, thanks to one or more features described below, the UE can control the content of exposure, the target application function of exposure, the duration of exposure, and the condition for stopping exposure. The implementations thus provide the user with flexibility of controlling its information exposed to a network based on the executed application. The implementations also advantageously improve the security and privacy in network communications involving a large amount of UEs and application functions.

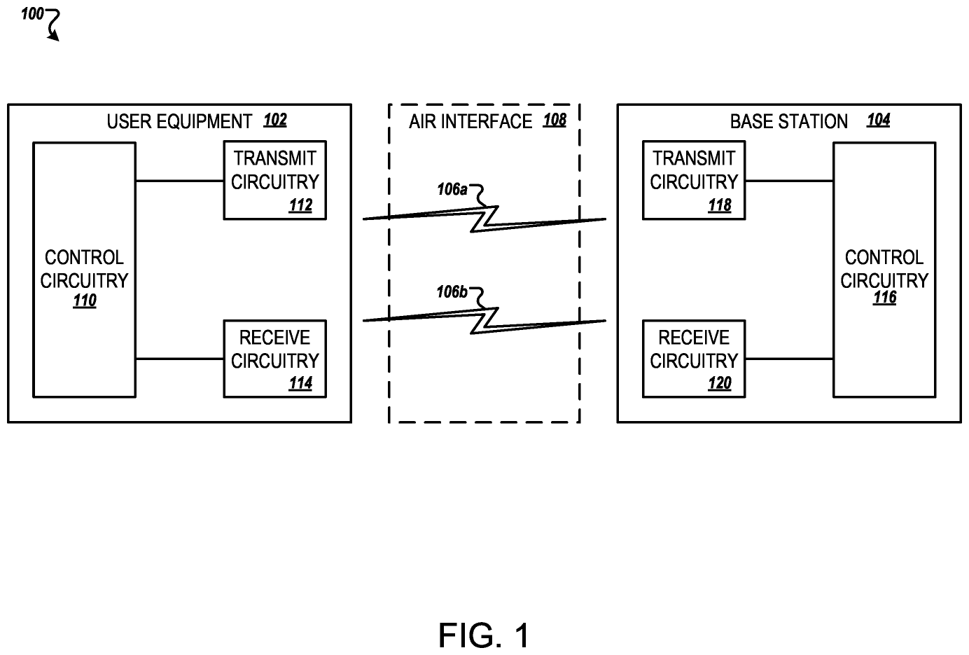

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates LTE and 5G NR communication standards as defined by the 3GPP technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can control the execution of the application client, determine what information to expose to the application function, and manage the exposure consent communicated to the communication network.

The transmit circuitry 112 can perform various operations described in this specification. For example, the transmit circuitry 112 can transmit data from the application client to the application function via the communication network or transmit the consent of exposure to one or more application functions in the communication network. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can receive data from the application function via the communication network. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer. In some implementations, the base station 104 may include one or more network devices or entities that form a 5GC or other types of communication network via which the UE 102 and the application function communicates. In some implementations, the application function is situated on an entity as part of the base station 104.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

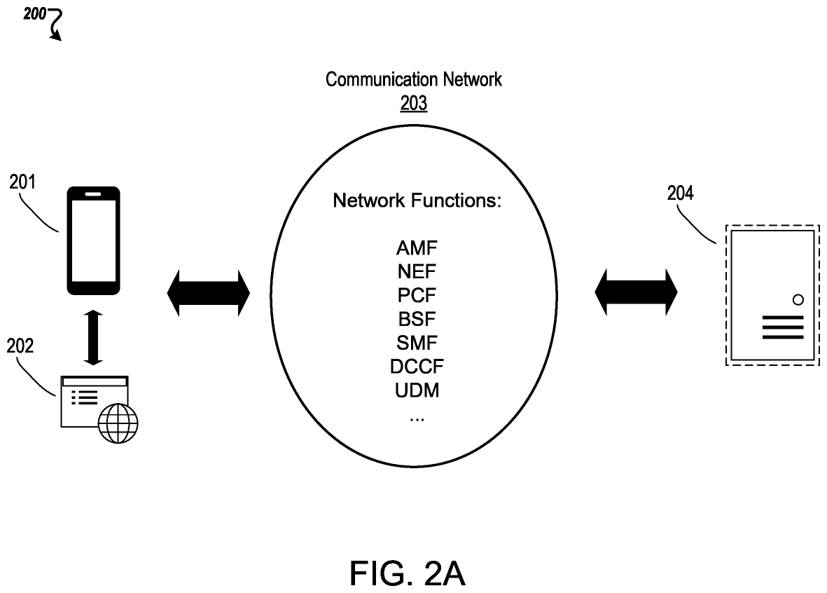

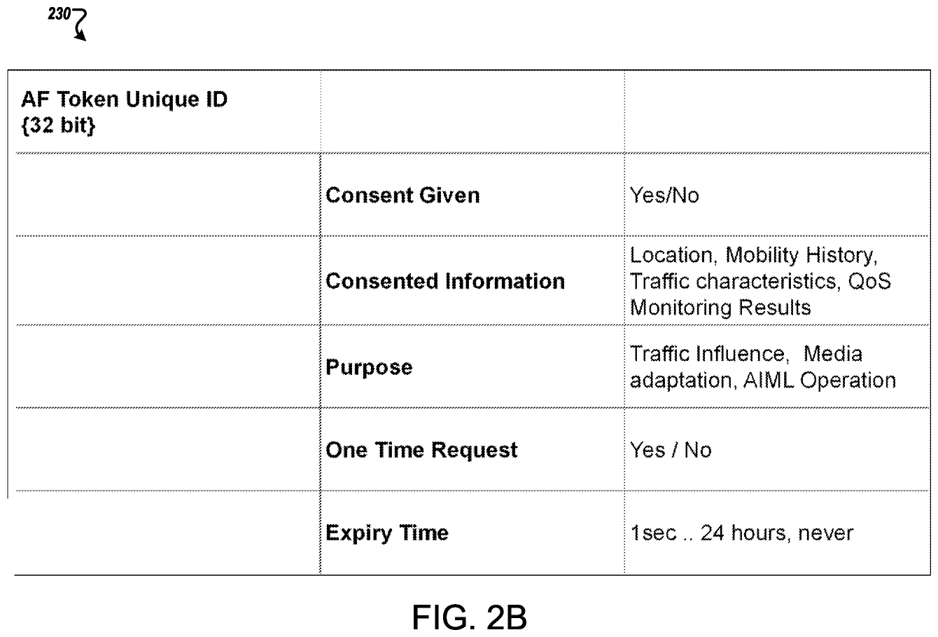

FIG. 2A illustrates wireless system 200 in which UE 201 communicates with network entity 204 via communication network 203, according to some implementations. UE 201 may be similar to UE 102 of FIG. 1, and communication network 203 may form part of base station 104 of FIG. 1. Wireless system 200 can be configured with features described below that allow UE 201 to expressly consent exposure of UE-related information to network entity 204.

In wireless system 200, UE 201 executes application client 202 by accessing the software code of application client 202. The software code of application client 202 may be stored on the hardware of UE 201 or on a different device communicatively coupled to UE 201. By executing application client 202, UE 201 communicates with network entity 204.

Network entity 204 can be an entity where application function services are stored and performed. In some implementations, network entity 204 can be formed as an EES entity, and the application function services can include services executable by an EES. Correspondingly, application client 202 can include an EEC.

Communication network 203 supports the wireless communication between application client 202 (via UE 201) and network entity 204. In some implementations, communication network 203 includes one or more network entities on which various network functions are stored and performed. The network functions can include, e.g., AMF, NEF, PCF, BSF, SMF, DCCF, and UDM. Network entity 204 may or may not be situated within communication network 203.

As discussed above, when application function desires to access UE-related information for communicating with application client 202, UE 201 may want to control whether to expose the information to application function 204. To this end, one or more implementations use an AF token for UE 201 to expressly consent the content, duration, and conditions of the exposure.

FIG. 2B illustrates an example AF token 230, according to some implementations. AF token 230 can be a data object structured with, e.g., a unique AF token ID and one or more fields describing the consent. The AF token ID can be of a fixed size, such as 32 bits, or of a variable size. Because some implementations contemplate multiple application functions connected to a communication network, the AF token ID can uniquely identify each application function. This feature makes it possible for a UE to consent different information for different application functions and indicate the consented information in different AF tokens. Example AF token fields include: “Consent Given,” “Consented Information,” “Purpose,” “One-Time Request,” and “Expiry Time.” The values of these fields can be set to describe whether a UE consents exposure of UE-related information and other configurations of the consent.

Back to FIG. 2A, in some implementations, the AF token, such as AF token 230, is provided from the application function to application client 202. UE 201 obtains the AF token from application client 202, determines information about the exposure consent, updates the AF token with the information about the exposure consent, and provides the updated AF token to communication network 203.

In some implementations, the AF token is generated by UE 201 based on a user's authorization of exposing the UE-related information, where the authorization may apply to one or more specific application functions as exposure targets or may generally apply to all requesting application functions. After generating the AF token, UE 201 updates the AF token with the information about the exposure consent, and provides the updated AF token to communication network 203. In addition, application client 202 can transmit, via UE 201, the updated token to the application function.

Multiple options are available for UE 201 to transmit the updated AF token to communication network 203. In some implementations, UE 201 transmits the updated AF token to the UDM of communication network 203 via application signaling, e.g., as part of subscription data exchanged between application client 202 and the application function on network entity 204. In some implementations, UE 201 transmits the updated AF token to the SMF of communication network 203 via SM signaling, e.g., as part of PCO. In some implementations, UE 201 transmits the updated AF token to the DCCF of communication network 203 via user plane signaling. In some implementations, UE 201 transmits the updated AF token to the PCF (e.g., UE policy framework) of communication network 203 via NAS transport.

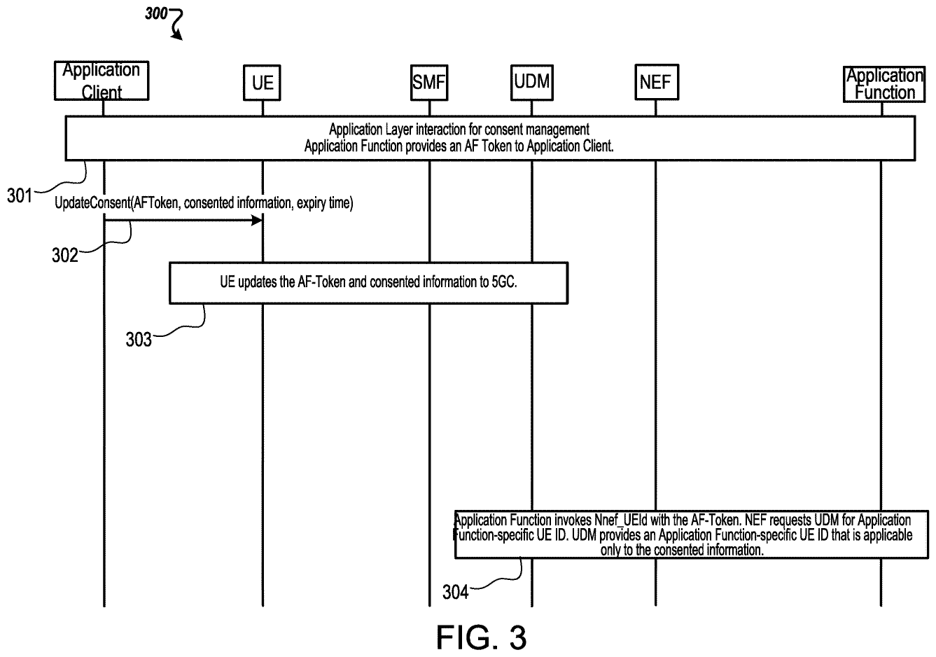

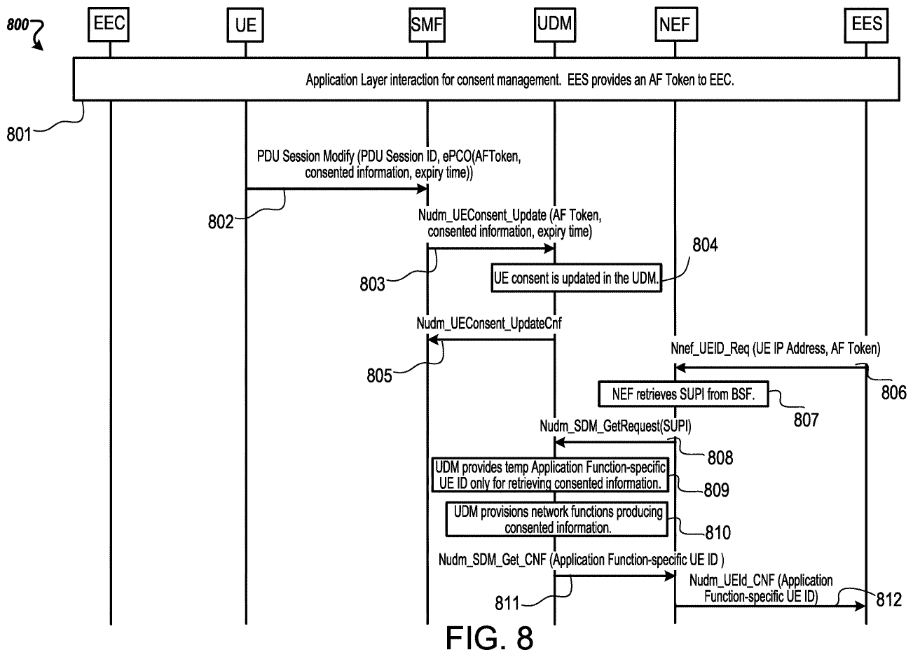

Whether the AF token is generated by the application function or by UE 201, the AF token can inform communication network 203 of consented exposure of UE-related information. In the meantime, when the application function wants to access the UE-related information, the application function can use the same AF token—either generated by the application function or generated by and received from UE 201—as a reference and requests communication network 203 to expose the requested UE-related information. Based on the request from the application function and the consent specified in the AF token, communication network 203 allows the application function to access only the UE-related information authorized by UE 201. As such, the application function can obtain its desired UE-related information subject to the consent of UE 201. Example flows of operations are described below with reference to FIGS. 3-8. In these examples, the application client (including the EEC in FIG. 8), the UE, the AF token, the network functions, and the application function (including the EES in FIG. 8) can be substantially the same as application client 202, UE 201, AF token 230, the network functions of communication network 203, and the application function on network entity 204, respectively, in FIGS. 2A and 2B. FIGS. 3-8 assume the network functions are situated on a 5GC.

FIG. 3 illustrates a flowchart showing example operations 300 involving a UE, an application function, and one or more network functions, according to some implementations. Operations 300 can correspond to implementations where the AF token is generated by UE 201.

At 301, the application function and the application client exchange application layer data about consent management for executing the application. Through such interaction, the application function provides the application client with an AF token. The AF token can indicate, e.g., an ID of the application function and the UE-related information requested by the application function.

At 302, the application client makes a decision about whether to grant exposure and instructs the UE to update the AF token accordingly. For example, the application client can send an “UpdateConsent” instruction to the operating system of the UE with the instruction indicating which AF token to update, what information to grant exposure, and an expiry time of the consent.

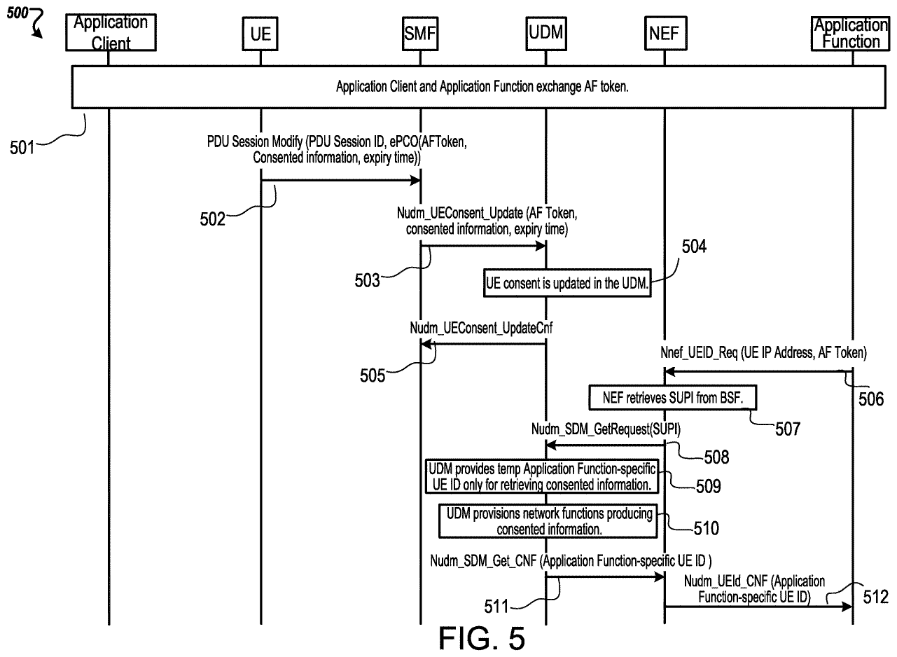

At 303, the UE updates the AF token according to the instruction from the application client and sends the AF token along with the consented information to the 5GC. The transmission can be based on one or more mechanisms described previously, such as application signaling, session management signaling, user plane signaling, and via NAS transport. Several of these mechanisms are later described in the flowcharts of FIGS. 5-7.

At 304, the application function requests access to the UE-related information. The request can include invoking the Nnef_UEId service while providing the AF token to the NEF of the 5GC. The NEF can forward the application function's request to the UDM and further request the UDM to provide an application function-specific UE ID. The UDM can validate the request from the NEF based on the consented information indicated by the UE at 303. The UDM then determines the application function-specific UE ID that grants the application function access to the consented UE-related information. By obtaining the application function-specific UE ID from the UDM, the application function can request the network functions of the 5GC to expose the consented UE-related information. More details of the features involved in 304 are described below with reference to FIGS. 5-7.

With the operations described above, operations 300 provide a mechanism for the UE to control access to UE-related information using an AF token provided by the application function.

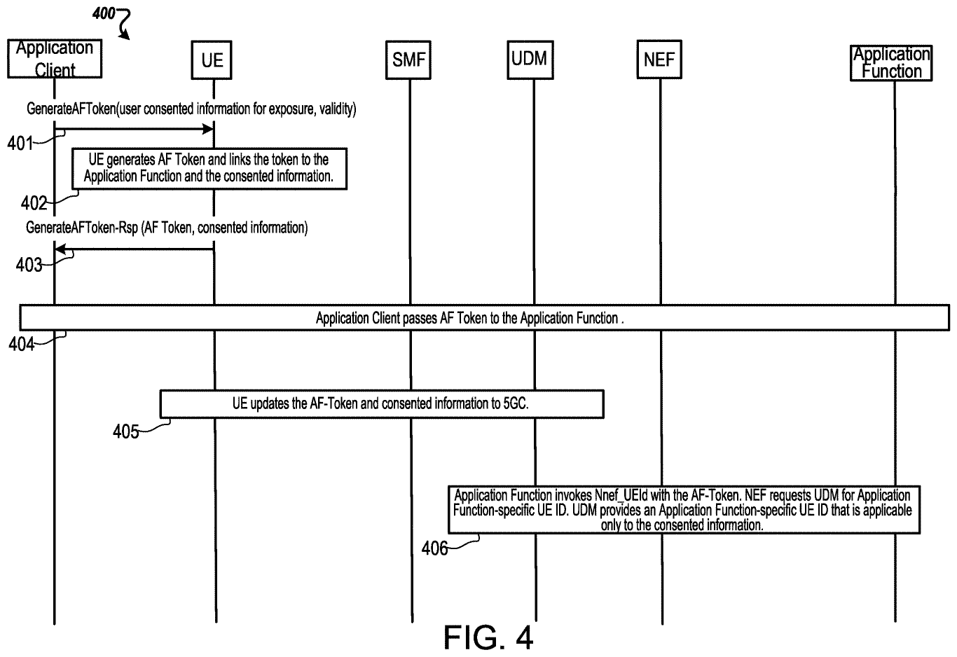

FIG. 4 illustrates a flowchart showing example operations 400 involving a UE, an application function, and one or more network functions, according to some implementations. Operations 400 can correspond to implementations where the AF token is generated by the application function and provided to application client 202.

At 401, based on the needs for executing the application with the application function, the application client instructs the UE to generate an AF token. For example, the application client can send an “GenerateAFToken” instruction to the operating system of the UE with the instruction indicating the UE-related information consented for exposure and the validity period of the consent.

At 402, the UE generates an AF token according to the instruction from the application client, and links the AF token with the application function. For example, the UE can specify the ID of the application function in a field of the application function to indicate that exposure of consented information is granted to a specific application function.

At 403, the UE sends a response to the application client. For example, the UE can send a message GenerateAFToken-Rsp to confirm that an AF token has been generated for the consented information.

At 404, the application client passes the UE-generated AF token to the application function. The application client can use the UE's hardware to transmit the AF token or can use the hardware of another device to transmit the AF token.

At 405, the UE updates the AF token according to the instruction from the application client and sends the AF token along with the consented information to the 5GC. The transmission at 405 can be substantially the same as 303 in FIG. 3.

At 406, the application function requests access to the UE-related information using the AF token as a reference. The requesting at 406 can be substantially the same as 304 of FIG. 3 and is not described in detail.

With the operations described above, operations 400 provide a mechanism for the UE to control access to UE-related information using an AF token generated by the UE and provided to the application function.

FIG. 5 illustrates a flowchart showing example operations 500 involving a UE, an application function, and one or more network functions, according to some implementations. Operations 500 can correspond to implementations where the AF token, after being updated by UE 201, is transmitted to the SMF of communication network 203 via session management signaling. In operations 500, the UE can obtain the AF token either by generating the AF token by itself or by causing the application client to receive the AF token from the application function.

At 501, the application client and the application function exchange the AF token. The exchange can be substantially the same as 301 in FIG. 3 where the AF token is generated by the application function and provided to the application client, or can be substantially the same as 401-404 in FIG. 4 where the AF token is generated by the UE and provided to the application function. Either approach taken, at the end of 501, the AF token can be updated with the consented UE-related information.

At 502, the UE provides the AF token, which indicates the consented UE-related information and the expiry time, to the SMF of the 5GC. The indication can be transmitted within a protocol data unit (PDU) Session Modify instruction for modifying a PDU session specified by a PDU session ID. In the PDU Session Modify instruction, the UE can include an extended PCO (ePCO) message that provides the AF token, the consented information, and the expiry time.

At 503, the SMF further transmits the AF token, the consented information, and the expiry time to the UDM. The transmission from the SMF to the UDM can use, e.g., an “Nudm_UEConsent_Update” message.

At 504, the UDM updates its record of UE consented exposure. The update can be, e.g., overwriting existing records or adding a new record.

At 505, the UDM confirms the update of UE consented exposure. The confirmation can be via an “Nudm_UEConsent_UpdateCnf” message transmitted back to the SMF.

At 506, the application function requests access to the UE-related information by, e.g., invoking an Nnef_UEId_Req service to provide the UE's IP address and the AF token to the NEF. The IP address can be used to locate the UE in the 5GC and the AF token can be used to determine what information can be exposed to the application function based on the UE's consent.

At 507, the NEF retrieves from the BSF the SUPI as an output of the Nnef_UEId_Req service.

At 508, the NEF invokes a subscriber data management (SDM) service at the UDM based on the SUPI. For example, the NEF can invoke Nudm_SDM_GetRequest (SUPI) at the UDM.

At 509, based on the updated records about UE consented exposure, the UDM generates a temporary application function-specific UE ID that can be used to access only to the consented UE-related information.

At 510, the UDM provisions (e.g., makes services available) only the network functions that produce the consented information. For example, the UDM can allow these network functions to expose the produced consented information to the application function to honor the UE's consent as indicated by the application function-specific UE ID.

At 511, the UDM provides the application function-specific UE ID to the NEF via, e.g., an “Nudm SDM_Get_CNF” message.

At 512, the NEF forwards the application function-specific UE ID to the application function via, e.g., an “Nudm_UEId_CNF” message. As such, the application function can use the application function-specific UE ID to access the consented information from the network functions provisioned by the UDM.

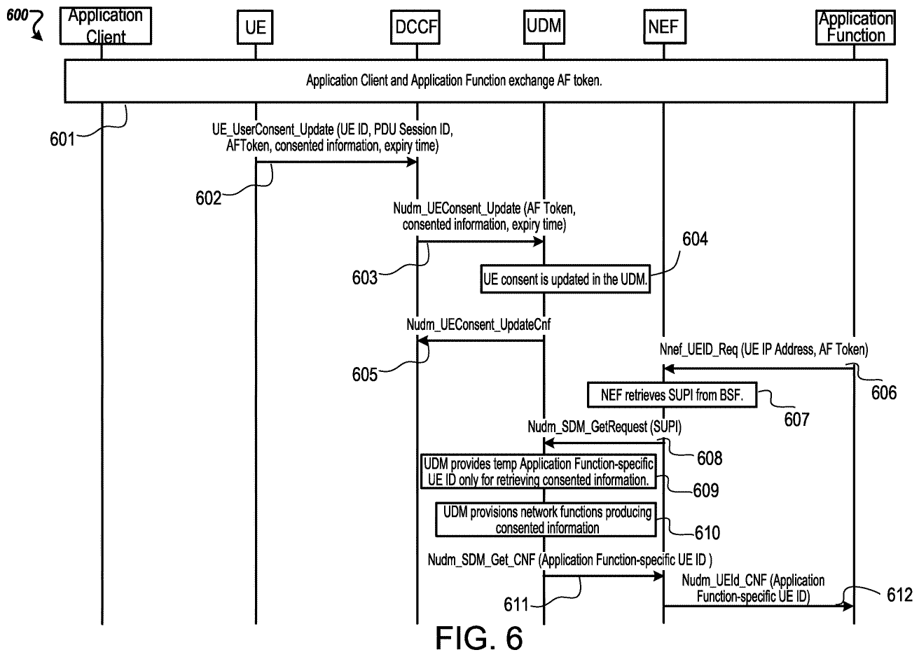

FIG. 6 illustrates a flowchart showing example operations 600 involving a UE, an application function, and one or more network functions, according to some implementations. Operations 600 can correspond to implementations where the AF token, after being updated by UE 201, is transmitted to the DCCF of communication network 203 via user plane signaling. In operations 600, the UE can obtain the AF token either by generating the AF token by itself or by causing the application client to receive the AF token from the application function.

At 601, the application client and the application function exchange the AF token. The exchange can be substantially the same as 501 of FIG. 5.

At 602, the UE provides the AF token, which indicates the consented UE-related information and the expiry time, to the DCCF of the 5GC. The indication can be transmitted by invoking a “UE_UserConsent_Update” service, which provides, e.g., an ID of the UE, the AF token, the consented information, and the expiry time, to the DCCF. In some implementations, in particular where the application function includes single network slice selection assistance information (S-NSSAI) or data network name (DNN), the “UE_UserConsent_Update” service may additionally provide a PDU session ID to link the consented information to a PDU session.

At 603-605, the UDM receives the AF token, the consented information, and the expiry time, updates its record of UE consented exposure, and confirm the update. 603-605 can be substantially the same as 503-505 of FIG. 5 except for using DCCF in lieu of SMF.

606-612 can be substantially the same as 506-512 of FIG. 5. Accordingly, description of 606-612 is thus omitted for brevity.

With the operations described above, operations 600 provide another mechanism for the application function to access the consented information from the network functions.

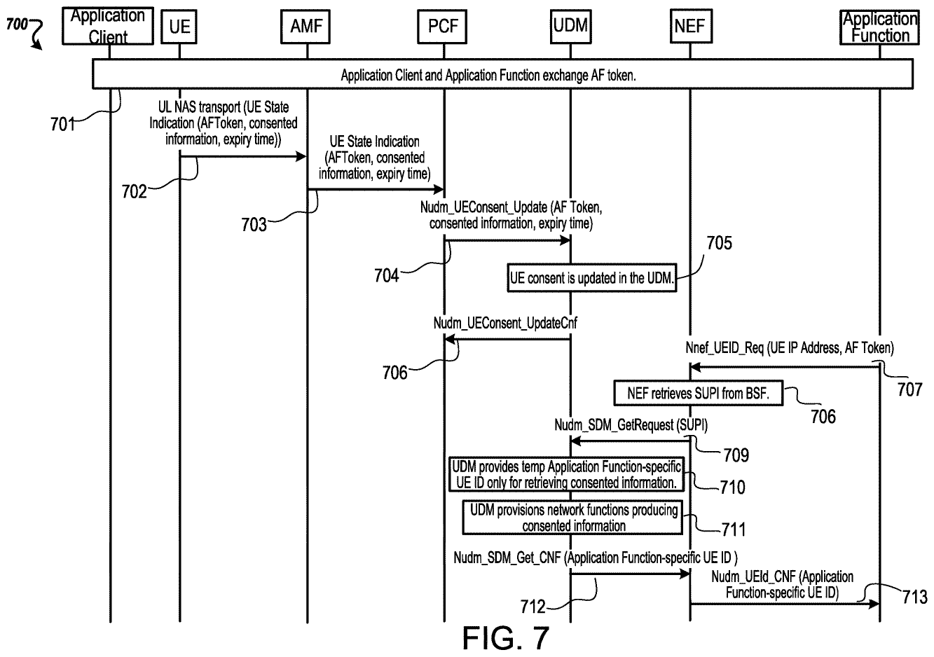

FIG. 7 illustrates a flowchart showing example operations 700 involving a UE, an application function, and one or more network functions, according to some implementations. Operations 700 can correspond to implementations where the AF token, after being updated by UE 201, is transmitted to the PCF of communication network 203 via NAS transport. In operations 700, the UE can obtain the AF token either by generating the AF token by itself or by causing the application client to receive the AF token from the application function.

At 701, the application client and the application function exchange the AF token. The exchange can be substantially the same as 501 of FIG. 5 or 601 of FIG .6.

At 702, the UE provides the AF token, which indicates the consented UE-related information and the expiry time, to the AMF of the 5GC. The indication can be transmitted by invoking a “UL NAS transport” service. For example, the UL NAS transport can transmit a container object “UE State Indication” to the AMF, where the AF token, the consented information, and the expiry time can be included in the “UE State Indication” container.

At 703, the AMF forwards the “UE State Indication” container to the PCF.

At 704-706, the UDM receives the AF token, the consented information, and the expiry time, updates its record of UE consented exposure, and confirm the update. 704-706 can be substantially the same as 503-505 of FIG. 5 except for using PCF in lieu of SMF.

707-713 can be substantially the same as 506-512 of FIG. 5. Accordingly, description of 707-713 is thus omitted for brevity.

With the operations described above, operations 700 provide another mechanism for the application function to access the consented information from the network functions.

FIG. 8 illustrates a flowchart showing example operations 800 involving a UE, an EES, and one or more network functions, according to some implementations. In operations 800, the UE is communicatively coupled to an EEC. The EEC executes an application with the EES.

At 801, the EES and the EEC exchange data at application layer. Through such interaction, the EES provides the EEC with an AF token. The exchange can be substantially the same as 301 of operations 300 shown in FIG. 3.

At 802-812, the UE informs the communication network, including the SMF, the UDM, and the NEF, of the exposure consent, and the communication network grants the EES access to UE-related information whose exposure is consented by the UE. 802-812 can be substantially the same as 502-512 of operations 500 in FIG. 5. Description of 802-812 is omitted for brevity.

With the operations described above, operations 800 provide a mechanism particularly for the EES to access the consented information from the network functions.

Besides the features in operations 300-800 described above, in some implementations, the application client is configured with the ability to revoke exposure consent at any time. The revocation can be conveyed via a signal to the communication network, in particular the UDM that keeps records of the exposure consent, to invalidate the AF token. Once the UDM receives the revocation signal, the UDM can instruct the NEF to deny the application function's access request to the consented information. The ability to revoke an exposure consent further improves the UE security and privacy.

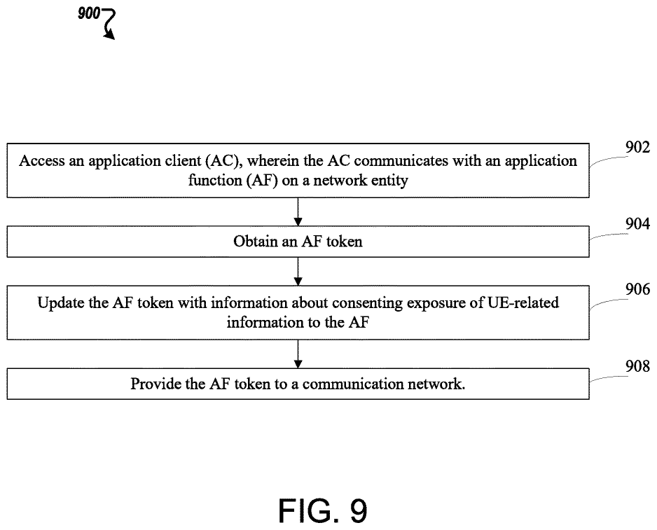

FIG. 9 illustrates a flowchart of an example method 900, according to some implementations. For clarity of presentation, the description that follows generally describes method 900 in the context of the other figures in this description. For example, method 900 can be performed by UE 102 of FIG. 1 or UE 201 of FIG. 2A. It will be understood that method 900 can be performed, for example, by any suitable system, environment, software, hardware, or a combination of systems, environments, software, and hardware, as appropriate. In some implementations, various steps of method 900 can be run in parallel, in combination, in loops, or in any order.

At 902, method 900 involves accessing an application client, wherein the application client communicates with an application function on a network entity. The application client can be similar to application client 202 of FIG. 2A, the application clients illustrated in FIGS. 3-7, or the EEC illustrated in FIG. 8. The network entity can be similar to network entity 204 of FIG. 2A. The application function can be similar to the application functions illustrated in FIGS. 3-7, or the EES illustrated in FIG. 8.

At 904, method 900 involves obtaining an AF token. The AF token can be similar to AF token 230 of FIG. 2B or the AF tokens illustrated in FIGS. 3-8.

At 906, method 900 involves updating the AF token with information about consenting exposure of UE-related information to the application function. The updating can be similar to 303 or 405 described previously.

At 908, method 900 involves providing the AF token to a communication network. The communication network can be similar to communication network 203 of FIG. 2A or the 5GC illustrated in FIGS. 3-8.

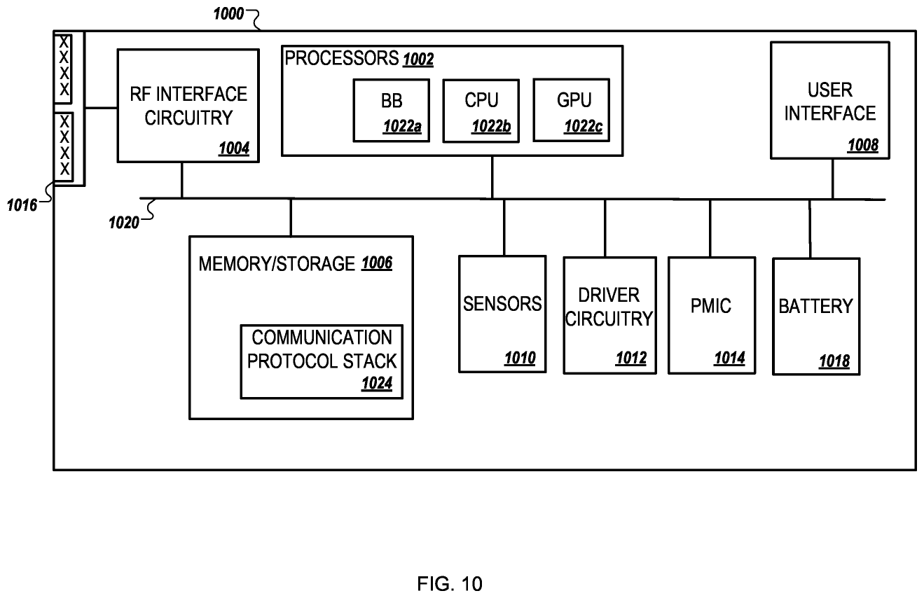

FIG. 10 illustrates a UE 1000, according to some implementations. The UE 1000 may be similar to and substantially interchangeable with UE 102 of FIG. 1 and UE 201 of FIG. 2A.

The UE 1000 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, antenna structure 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein. These operations can include, obtaining the AF token either from the application function or by generating the AF token, updating the AF token with exposure consent, and revoking exposure consent.

In some implementations, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1004. The baseband processor circuitry 1022A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some implementations, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc. The RF interface circuitry 1004 can be configured to, e.g., exchange application data with the application function or transmit the AF token to the communication network.

In the receive path, the RFEM may receive a radiated signal from an air interface via antenna structure 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1016. In various implementations, the RF interface circuitry 1004 may be configured to transmit/receive signals in a manner compatible with NR access technologies.

The antenna 1016 may include antenna elements to convert electrical signals into radio waves to travel through the air and to convert received radio waves into electrical signals. The antenna elements may be arranged into one or more antenna panels. The antenna 1016 may have antenna panels that are omnidirectional, directional, or a combination thereof to enable beamforming and multiple input, multiple output communications. The antenna 1016 may include microstrip antennas, printed antennas fabricated on the surface of one or more printed circuit boards, patch antennas, phased array antennas, etc. The antenna 1016 may have one or more panels designed for specific frequency bands including bands in FR1 or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensor circuitry 1028 and control and allow access to sensor circuitry 1028, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some implementations, the PMIC 1014 may control, or otherwise be part of, various power saving mechanisms of the UE 1000. A battery 1018 may power the UE 1000, although in some examples the UE 1000 may be mounted deployed in a fixed location, and may have a power supply coupled to an electrical grid. The battery 1018 may be a lithium ion battery, a metal-air battery, such as a zinc-air battery, an aluminum-air battery, a lithium-air battery, and the like. In some implementations, such as in vehicle-based applications, the battery 1018 may be a typical lead-acid automotive battery.

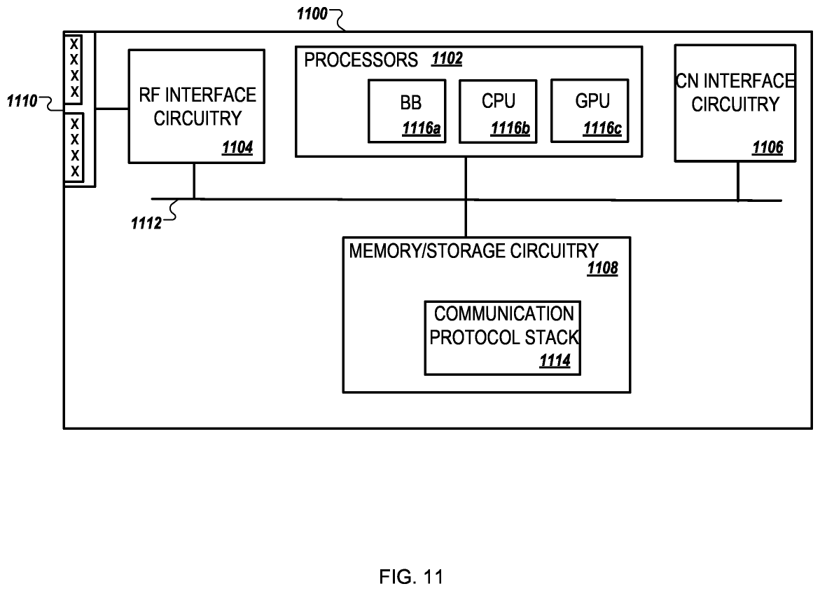

FIG. 11 illustrates an access node 1100 (e.g., a base station or gNB), according to some implementations. The access node 1100 may be similar to and substantially interchangeable with base station 104 and may include network devices on which one or more network functions are executed. The access node 1100 may include processors 1102, RF interface circuitry 1104, core network (CN) interface circuitry 1106, memory/storage circuitry 1108, and antenna structure 1110.

The components of the access node 1100 may be coupled with various other components over one or more interconnects 1112. The processors 1102, RF interface circuitry 1104, memory/storage circuitry 1108 (including communication protocol stack 1114), antenna structure 1110, and interconnects 1112 may be similar to like-named elements shown and described with respect to FIG. 10. For example, the processors 1102 may include processor circuitry such as, for example, baseband processor circuitry (BB) 1116A, CPU 1116B, and GPU 1116C.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various implementations, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1100 may be implemented as one or more software entities running on server computers as part of a virtual network, which may be referred to as a CRAN and/or a virtual baseband unit pool (vBBUP). In V2X scenarios, the access node 1100 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A processor comprising circuitry that executes instructions to cause a user equipment (UE) to perform operations comprising:
accessing an application client (AC), wherein the AC communicates with an application function (AF) on a network entity;
obtaining an AF token;
updating the AF token with information about consenting exposure of UE-related information to the AF; and
providing the AF token to a communication network.

2. The processor of claim 1, wherein obtaining the AF token comprises:
causing the AC to receive the AF token from the AF; and
obtaining the AF token from the AC.

3. The processor of claim 2, wherein obtaining the AF token further comprises:
obtaining an indication of consenting the exposure of the UE-related information and an indication of a token expiry time from the AC.

4. The processor of claim 1, wherein obtaining the AF token comprises:
obtaining a message from the AC; and
generating the AF token based on the message.

5. The processor of claim 4, wherein the message comprises:
an indication of the UE-related information;
an authorization of exposing the UE-related information to the AF; and
an indication of a validity time of the exposure.

6. The processor of claim 1, wherein providing the AF token to the communication network comprises:
providing the AF token as part of UE subscription data via application layer signaling to a unified data management (UDM) entity in the communication network.

7. The processor of claim 1, wherein providing the AF token to the communication network comprises:
providing the AF token as part of protocol configuration options (PCO) to a session management (SM) entity.

8. The processor of claim 1, wherein providing the AF token to the communication network comprises:
providing the AF token via user plane signaling to a data collection coordination function (DCCF) entity in the communication network.

9. The processor of claim 1, wherein providing the AF token to the communication network comprises:
providing the AF token via non-access stratum (NAS) transport to a policy control function (PCF) entity in the communication network.

10. The processor of claim 1, wherein the AC comprises an edge enabler client (EEC) and the AF comprises an edge enabler server (EES).

11. A user equipment (UE) comprising a processor configured to perform operations comprising:
accessing an application client (AC), wherein the AC communicates with an application function (AF) on a network entity;
obtaining an AF token;
updating the AF token with information about consenting exposure of UE-related information to the AF; and
providing the AF token to a communication network.

12. The UE of claim 11, wherein obtaining the AF token comprises:
causing the AC to receive the AF token from the AF; and
obtaining the AF token from the AC.

13. The UE of claim 12, wherein obtaining the AF token further comprises:
obtaining an indication of consenting the exposure of the UE-related information and an indication of a token expiry time from the AC.

14. The UE of claim 11, wherein obtaining the AF token comprises:
obtaining a message from the AC; and
generating the AF token based on the message.

15. The UE of claim 14, wherein the message comprises:
an indication of the UE-related information;
an authorization of exposing the UE-related information to the AF; and
an indication of a validity time of the exposure.

16. The UE of claim 11, wherein providing the AF token to the communication network comprises:
providing the AF token as part of UE subscription data via application layer signaling to a unified data management (UDM) entity in the communication network.

17. The UE of claim 11, wherein providing the AF token to the communication network comprises:
providing the AF token as part of protocol configuration options (PCO) to a session management (SM) entity.

18. The UE of claim 11, wherein providing the AF token to the communication network comprises:
providing the AF token via user plane signaling to a data collection coordination function (DCCF) entity in the communication network.

19. The UE of claim 11, wherein providing the AF token to the communication network comprises:
providing the AF token via non-access stratum (NAS) transport to a policy control function (PCF) entity in the communication network.

20. A network device comprising a unified data management (UDM) entity and a network exposure function (NEF) entity, wherein:
the UDM entity receives, from a user equipment (UE), an application function (AF) token, the AF token comprising an indication of consenting exposure of UE-related information to an AF entity,
the NEF receives a first request from the AF entity for retrieving a UE identifier,
the NEF sends a second request to the UDM entity based on the first request,
in response to the second request, the UDM entity determines the UE identifier that is unique to the UE and to the AF entity,
the UDM entity provides the UE identifier to the AF, and
the UE identifier grants the AF entity access to the UE-related information according to the indication.
